(19) United States
(12) Patent Application Publication
(10) Pub. No.: US 2019/0162623 A1
(43) Pub. Date: May 30, 2019

(54) PRESSURE TEST DEVICE FOR AN INFLATOR HOUSING

(71) Applicant: TOYODA GOSEI CO., LTD., Kiyosu-shi (JP)

(72) Inventors: Shuichiro MAKINO, Kiyosu-shi (JP); Yuichi KINO, Kiyosu-shi (JP)

(21) Appl. No.: 16/183,978

(22) Filed: Nov. 8, 2018

(30) Foreign Application Priority Data
Nov. 29, 2017 (JP) 2017-229664

(51) Int. Cl. G01M 3/00; B60R 99/00

(52) U.S. Cl. CPC G01M 3/002; B60R 2021/26076; B60R 99/00

(57) ABSTRACT

A pressure test device for testing a heat resistance of an inflator housing is disclosed. The inflator housing is made from metal into a generally cylindrical contour and is filled with a gas. The test device includes a heating apparatus for heating the inflator housing. The heating apparatus includes a conducting wire, a heating coil that is connected with the conducting wire and causes induction heating in the inflator housing as set at a heating position, and a power supply that feeds a high-frequency electric current to the conducting wire.

### CROSS REFERENCE TO RELATED APPLICATIONS

The Present application claims priority from Japanese Patent Application No. 2017-229664 of Makino et al., filed on Nov. 29, 2017, the entire disclosure of which is incorporated herein by reference.

### BACKGROUND OF THE INVENTION

### 1. Field of the Invention

The present invention relates to a pressure test device for a housing of an inflator which is used in an airbag device for a vehicle.

### 2. Description of Related Art

Conventionally, an inflator for use in an airbag device is formed by inserting such a gas as a nitrogen gas, in a pressurized form, in a generally cylindrical housing made from such high strength metal as iron. When fed with an actuating signal, a squib and/or a micro gas generator disposed inside the inflator housing is ignited, which initiates burning of propellant. The burnt propellant generates gases, the gasses pressurize the housing, and a burst disc that has partitioned the housing breaks, then the pressurized gases are discharged from gas discharge ports formed in a leading end region of the housing, thereby inflating an airbag.

Pressure resistance of an inflator housing is very important for a secure deployment of the airbag because a problem in pressure resistance may cause a gas leakage. Thus inflator housings are subjected to pressure test prior to use. JP 2003-35643 A discloses a pressure test device for an inflator housing. The device tests pressure resistance of an inflator housing by injecting water into the housing and checking whether water leakage occurs or not.

Other types of pressure test device includes one that conducts a test by placing an inflator housing filled with gases (i.e. pressurized gases) in an electric furnace, heating the housing in the furnace and checking whether gas leakage occurs or not.

However, the testing using water requires removal of the water after the testing, which complicates the testing. The testing using an electric furnace requires a lot of time and a great deal of energy for heating the air in the furnace in order to heat and pressurize the inflator housing.

### SUMMARY OF THE INVENTION

The invention contemplates a solution to the above-mentioned problems, and has an object to provide a pressure test device for an inflator housing which is capable of conducting a pressure test easily and quickly with less energy.

The object of the invention will be achieved by a following pressure test device for an inflator housing:

The pressure test device for testing a heat resistance of an inflator housing includes a heating apparatus that heats the inflator housing which is made from metal into a generally cylindrical contour and is filled with a gas. The heating apparatus includes a conducting wire, a heating coil that is connected with the conducting wire and causes induction heating in the inflator housing as set at a heating position, and a power supply that feeds a high-frequency electric current to the conducting wire.

With the pressure test device of the invention, since the heating apparatus heats the inflator housing directly by means of induction heating, the inflator housing is heated more quickly for a pressure test than in a conventional way of testing with the use of an electric furnace. Further, the pressure test device of the invention uses less energy than the electric furnace in order to heat the inflator housing to a predetermined temperature. Further, the pressure test device of the invention is able to conduct a pressure test merely by heating an inflator housing filled with a gas, thus is able to conduct the test more easily than another conventional way of testing with the use of water.

Therefore, the pressure test device of the invention is conducive to an easier, quicker and more energy-saving pressure test of an inflator housing.

If the inflator housing as subjected to the pressure test is judged to have a sufficient pressure resistance (i.e. if the housing has no trace of gas leakage), it can be used as an inflator. To the contrary, if the inflator housing as ejected from the pressure test device shows a trace of gas leakage, it is unadapted for use as an inflator.

In the pressure test device of the invention, it is desired that the heating coil for causing induction heating is disposed at a position in a direction perpendicular to an axial direction of the inflator housing as set at the heating position.

With this configuration, since the inflator housing is generally cylindrical in outer contour and the heating coil is disposed at a position in the direction perpendicular to the axial direction of the inflator housing as set at the heating position, induction heating occurs generally uniformly in a generally entire area in the axial direction of the housing, thus heating the housing quickly.

In the above instance, it is further desired that the heating coil includes a void space that serves as an insert/eject port of the inflator housing into and out of the heating position, and that the heating coil is configured to cover a portion of an outer circumference of the inflator housing opposed to the void space over a generally entire length.

This configuration enables a setting and an ejection of the inflator housing as held by a suitable holding member, by way of example, in and out of the heating position to be conducted via the void space. Since no conducting wire is disposed in the void space, the setting and ejection of the inflator housing can be conducted easily with no fear of interference by the conducting wire, which will be conducive to a speed-up of the pressure test.

In this instance, it is desired that the heating coil is formed into such a bent plate shaped generally like a half-pipe that is adapted to encircle the portion of the outer circumference of the inflator housing opposed to the void space.

With this configuration, the heating coil encircles the outer circumference of the inflator housing in proximity over a generally entire length of the inflator housing as set at the heating position at an opposite side of the void space. This will improve an efficiency in induction heating of the inflator housing, thus contributing to energy-saving in the pressure test.

In the instance where the heating coil is formed into the bent plate as described above, it is desired that a projected contour of the heating coil as viewed from the axial direction of the inflator housing as set at the heating position is such a U shape that includes a semicircular arc portion which is opposed to the void space and covers a generally half circumference of the inflator housing and a pair of straight portions that extend straightly in parallel to each other from both ends of the semicircular arc portion, and that at least leading ends of the straight portions extend to a vicinity of a top of a portion of the outer circumference of the inflator housing disposed towards the void space.

With this configuration, when the inflator housing is disposed at the heating position, the semicircular arc portion of the heating coil encircles the generally half outer circumference of the housing in proximity at the opposite side of the void space and the straight portions sandwich the opposite portion of the outer circumference of the inflator housing in proximity though not in an encircling manner, thus the heating coil encircles a generally entire outer circumference of the inflator housing over the entire length except a portion facing the void space. Therefore, the heating coil is able to heat the inflator housing efficiently by induction heating. Needless to say, the void space has an opening width greater than a diameter of the inflator housing and is disposed at a position in the direction perpendicular to the axial direction of the inflator housing as set at the heating position, thereby facilitating setting and ejection of the inflator housing in and out of the heating position by the heating coil.

Furthermore, in the instance where the heating coil includes the void space as described above, the void space is desirably disposed at a lower portion of the heating coil such that the heating coil receives the inflator housing as laid horizontally from below the void space.

With this configuration, if the inflator housing as laid horizontally is moved upward into the heating coil via the void space, the inflator housing is set at the heating position proximate to the heating coil. With this configuration, furthermore, since the setting of the inflator housing at the heating position can be conducted merely by moving the housing upward, a holding member for holding the inflator housing has only to support an underside of the housing, i.e. does not have to be composed of a chucking mechanism or the like that grips the inflator housing. By way of example, the holding member will have only to include, on the top plane, a V-shaped or U-shaped holding recess that accommodates the inflator housing and prevents the same from slipping or rotating. Furthermore, although a chucking mechanism or the like would be likely to be formed of metal material, such a holding member that receives the inflator housing in the V-shaped groove or the like may be fabricated of non-conducting material like synthetic resin. That way the pressure test device will have only to heat the inflator housing but not the holding member, and heating of the inflator housing will be conducted further efficiently.

### BRIEF DESCRIPTION OF DRAWINGS

FIG. 1 is a schematic sectional view of an inflator composed of an inflator housing which is to be subjected to a pressure test with a pressure test device embodying the invention;

FIG. 2 illustrates a production process of the inflator of FIG. 1 schematically;

FIG. 3 is a schematic vertical sectional view of the pressure test device embodying the invention, taken along a direction perpendicular to an axial direction of the inflator housing;

FIG. 4 is a schematic vertical sectional view of the pressure test device of FIG. 3 taken along the axial direction of the inflator housing;

FIG. 5A is a plan view of a heating coil for use in the pressure test device as developed flatly;

FIG. 5B is a plan view of the heating coil as formed into a generally half-pipe contour;

FIG. 5C is a front elevation of the heating coil of FIG. 5B; and

FIG. 6 is a schematic perspective view of the heating coil of FIG. 5B.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

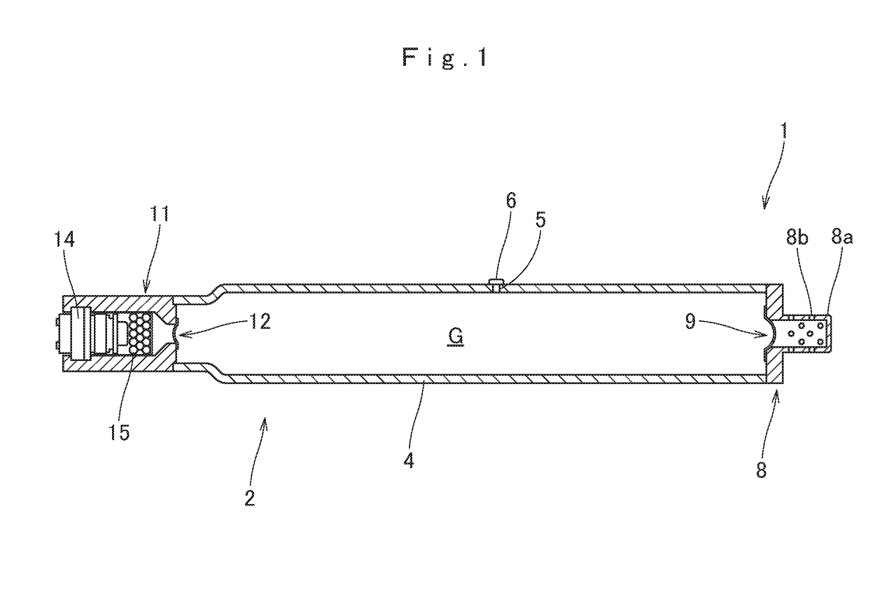

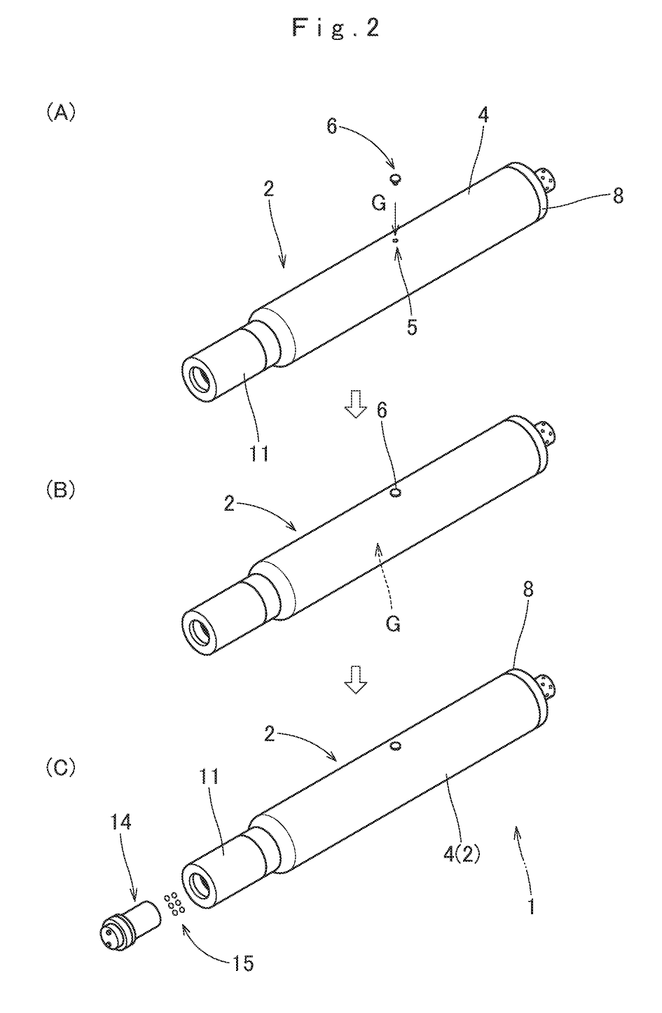

Firstly, an inflator 1 is described referring to FIGS. 1 and 2. The inflator 1 is formed including an inflator housing 2 which is to be subjected to a pressure test conducted with a pressure test device embodying the invention. The inflator 1 is a hybrid inflator which utilizes a combustion gas generated by burning of propellant and a pressurized gas G of nitrogen, argon or the like inserted in the housing 2 both for inflating an airbag. The housing 2 of the inflator 1 is generally cylindrical in outer contour, and includes a generally cylindrical body 4 having a constricted rear end, a discharging-side end cap 8 which is secured to the front end of the body 4 by welding or the like, and a squib-side end cap 11 which is secured to the rear end of the body 4 by welding or the like. The body 4 is composed of a hollow pipe. The discharging-side end cap 8 is provided with a head 8a having a plurality of gas discharging ports 8b. The squib-side end cap 11 stores there inside a quantity of propellant 15 and a squib 14 for igniting the propellant 15.

One each burst disc 9, 12 is disposed to seal the body 4 at a boundary between the body 4 and discharge-side end cap 8 and at a boundary between the body 4 and the squib-side end cap 11. Each of the burst discs 9 and 12 is rupturable when impacted by an impact wave generated by ignition of the squib 14 or pressure elevation due to burning of the propellant 15. The body 4 between the burst discs 9 and 12 is filled with the gas G under pressure of approximately between 35 and 70 MPa. When the inflator 1 is actuated, the squib 14 is ignited and burns the propellant 15. The burnt propellant 15 generates combustion gases, the gases break the burst disc 12, then when an internal pressure of the body 4 soars, the burst disc 9 breaks, thus the combustion gases of the propellant 15 and the pressurized gas G are discharged from the gas discharge ports 8b.

The body 4 and end caps 8 and 11 of the inflator housing 2 are formed from pressure-resistant metal material such as low-carbon steel or steel, which are conductor. The body 4 is provided, at a generally center in the front and rear direction, with an insert opening 5 from which the pressurized gas G is inserted. The insert opening 5 is stopped up by a stopper plug 6. The stopper plug 6 is formed from such metal material that can be used for resistance welding, such as low-carbon steel. The stopper plug 6 is welded to a periphery of the insert opening 5 by resistance welding.

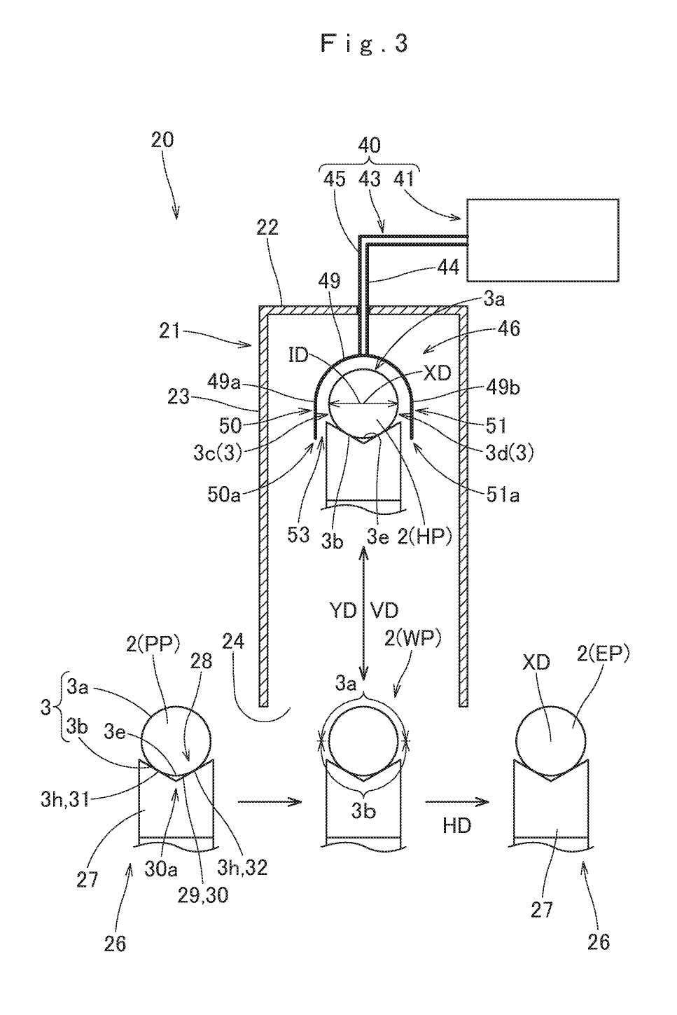

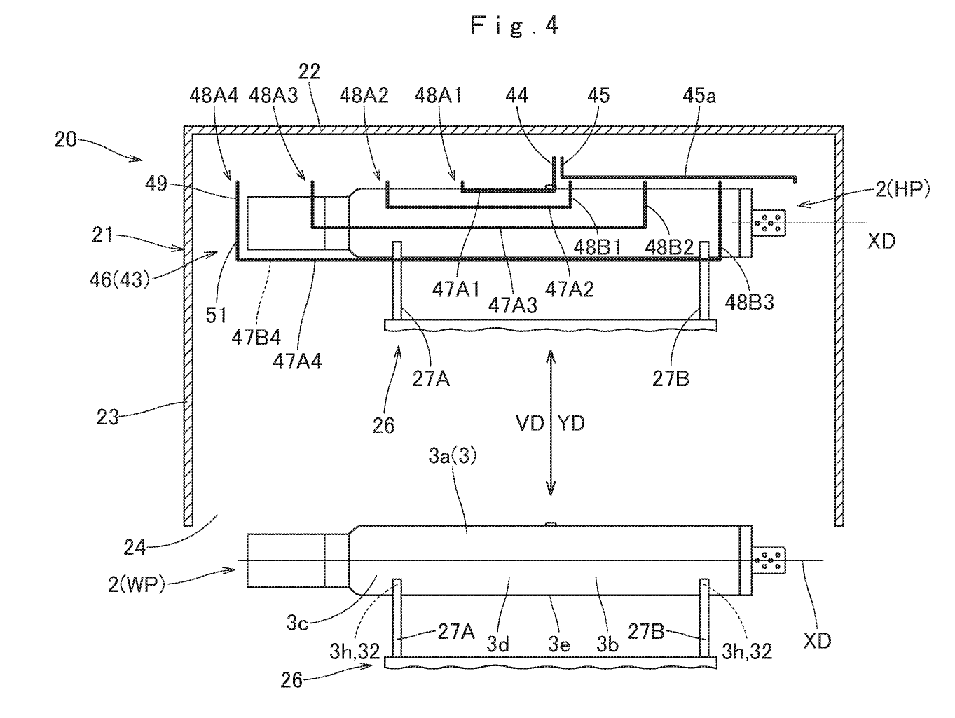

Production of the inflator 1 is now described. Firstly, the body 4 and the end caps 8 and 11 to which the burst discs 9 and 12 have been attached in advance, are provided. As shown in (A) of FIG. 2, the end caps 8 and 11 are welded to the opposite ends of the body 4 to form the housing 2. Then a pressurized gas G is inserted into the body 4 from the insert opening 5 as shown in (B) of FIG. 2, then the stopper plug 6 is put into the insert opening 5, and welded to the periphery of the opening 5. The inflator 1 or inflator housing 2 thus produced is subjected to a pressure test using a pressure test device 20 shown in FIGS. 3 and 4 in order to check whether the inflator 1 has an enough pressure resistance not to cause gas leakage. If the test result shows that the inflator 1 has an enough pressure resistance not to cause gas leakage, the propellant 15 is inserted into the squib-side end cap 11 and the squib 14 is secured to the squib-side end cap 11 as shown in (C) of FIG. 2. Thus the inflator 1 is completed.

As can be seen in FIGS. 3 and 4, the pressure test device 20 includes an induction heating apparatus 40, a holding member 26 that holds and transfers the inflator housing 2, and a cover 21 that covers the inflator housing 2 disposed at a heating position HP.

The cover 21 is fabricated of high strength metal such as iron, and includes a ceiling wall section 22, a side wall section 23 which extends downwardly from an outer circumferential edge of the ceiling wall section 22 in the form of a generally square tube, and a gateway 24 which is disposed at a lower region of the side wall section 23, apart from the ceiling wall section 22. The heating position HP of the inflator housing 2 is disposed proximate to and beneath the ceiling wall section 22. The housing 2 held by the holding member 26 is transferred upwardly to the heating position HP inside the cover 21 from a waiting position WP outside of the cover 21 via the gateway 24.

The holding member 26 includes one or more holding sections 27 that hold the housing 2, and is connected to a not-shown transfer mechanism. In the illustrated embodiment, the holding member 26 is configured to hold the housing 2 in such a manner that the axial direction XD of the housing 2 extends along a horizontal direction HD. The transfer mechanism is configured to move the holding member 26 as holding the housing 2 in an up and down direction as well as in the horizontal direction. More specifically, as can be seen in FIG. 3, the not-shown transfer mechanism is capable of moving the inflator housing 2 reciprocally from the waiting position WP disposed immediately below the gateway 4 of the cover 21 to a preparation position PP or to an ejection position EP disposed to a side in the horizontal direction HD, and from the waiting position WP to the heating position HP in the up and down direction VD. The transfer mechanism may be configured to conduct transfer of the housing 2 manually, or may be connected to a power supply 41 of the induction heating apparatus 40 so as to cooperate with the induction heating apparatus 40 and move the housing 2 automatically from the preparation position PP to the waiting position WP, heating position HP, then waiting position WP again and to the ejection position EP in parallel to a process of the pressure test.

Each of the holding sections 27 (27A, 27B) is formed into a plate which is provided with a holding recess 29 for receiving the inflator housing 2 on the top plane 28. In the illustrated embodiment, two of the holding sections 27 are provided at two spaced-apart positions in the axial direction XD so as to support an outer circumferential plane 3 of the housing 2 (i.e. of the body 4). In the illustrated embodiment, the holding recess 29 of each of the holding sections 27 is composed of a V-groove 30 which dents downwardly and includes a bottom 30a and a pair of flat supporting planes 31 and 32 extending upwardly from the bottom 30a in a V-shape. The holding sections 27 are each configured to support the outer circumferential plane 3 of the housing 2 as laid such that the axial direction XD extends along the horizontal direction HD, with the supporting planes 31 and 32. More particularly, the supporting planes 31 and 32 support portions 3h of a lower portion 3b of the outer circumferential plane 3 of the housing 2, which portions 3h are disposed on both sides of a top 3e of the lower portion 3b which protrudes most downwardly.

The holding member 26 is fabricated of heat-resistant synthetic resin, i.e. non-conducting material, including the holding sections 27.

The induction heating apparatus 40 includes a conducting wire 43, which is provided with an inductor or heating coil 46, and a power supply 41 that feeds a high-frequency electric current to the conducting wire 43.

The power supply 41 includes an inverter circuit and one or more operating switches, and feeds a high-frequency electric current to the conducting wire 43 through the use of a commercial power. The power supply 41 is configured to feed the current to the conducting wire 43 when the housing 2 is placed at the heating position HP, and is configured to stop the supply of current when the housing 2 is heated to a predetermined temperature required for the pressure test.

The conducting wire 43 includes lead wires 44 and 45 extending from the power supply 41 and the heating coil (inductor) 46 which is connected to the leading ends of the lead wires 44 and 45 so as to generate eddy currents in the housing 2 and induce heating of the housing 2. The heating coil 46 is arranged in a spiral pattern.

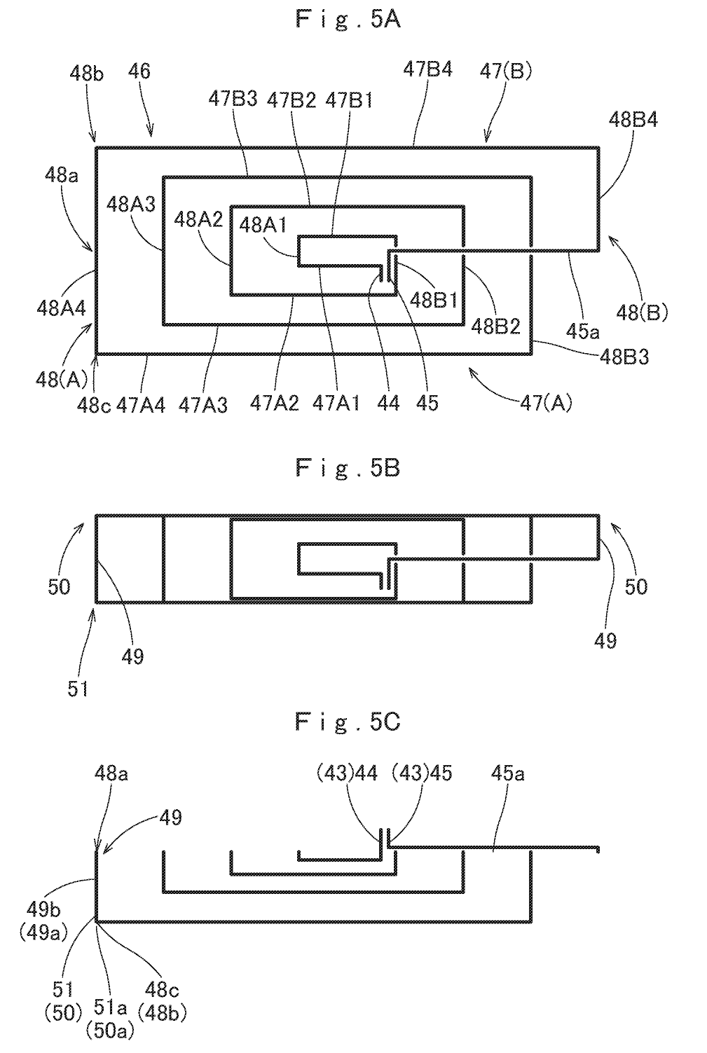

As can be seen in FIG. 5A, the heating coil 46 as flatly developed has a rectangular spiral contour that includes long sides 47 (47A and 47B) which are opposed to each other and short sides 48 (48A and 48B) which are opposed to each other. More particularly, starting the lead wire 44 at the center of the spiral, by way of example, the heating coil 46 extends outwardly forming rectangular frames with a long side 47A1, a short side 48A1, a long side 47B1, a short side 48B1, a long side 47A2, a short side 48A2, a long side 47B2, a short side 48B2, a long side 47A3, a short side 48A3, a long side 47B3, a short side 48B3, a long side 47A4, a short side 48A4, a long side 47B4, a short side 48B4, and leads to an extended region 45a of the lead wire 45 which is disposed proximate to the lead wire 44 disposed at the center of the spiral.

The long side 47 has such a dimension that covers a generally entire length of the housing 2, and the short side 48 has such a dimension that covers the outer circumferential plane 3 of the housing 2 generally entirely.

The heating coil 46 is disposed immediately below the ceiling wall section 22 of the cover 21 in a direction YD perpendicular to the axial direction XD of the housing 2 as positioned at the heating position HP so as to cause induction heating in the housing 2 positioned at the heating position HP. The heating coil 46 has a void space 53 that serves as an insert/eject port of the housing 2 into and out of the heating position HP, and encircles a portion of the outer circumferential plane 3 of the housing 2 opposed to the void space 53 over a generally entire length. In the illustrated embodiment, the heating coil 46 is formed into such a bent plate shaped like a half-pipe that is capable of covering the portion of the outer circumferential plane 3 of the housing 2 opposed to the void space 53 over the generally entire length, i.e. the upper portion 3a of the outer circumferential plane 3.

Such a shape of the heating coil 46 can be formed by bending the short sides 48 (48A, 48B) of the heating coil 46 as flatly developed as can be seen in FIG. 5A such that opposite ends 48b and 48c of each of the short sides 48A and 48B are disposed farther downward than the center 48a as shown in FIG. 5C.

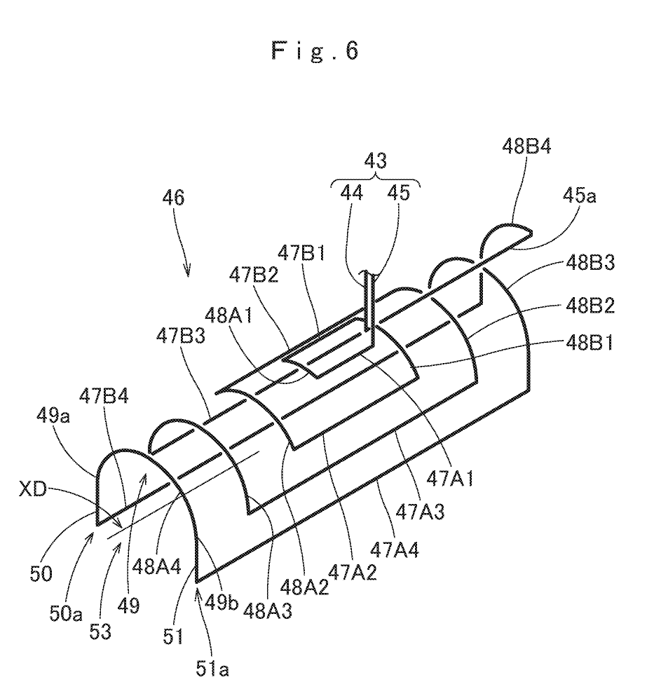

Moreover, as can be seen in FIGS. 3, 5B and 6, a projected contour of the heating coil 46 of the illustrated embodiment as viewed from the axial direction XD of the housing 2 as set in the heating position HP is such a U shape (more particularly, an inverse U shape) that includes a semicircular arc portion 49 that is opposed to the void space 53 and covers a generally half circumference of the housing 2 and a pair of straight portions 50 and 51 that extend straightly downward in parallel to each other from both ends 49a and 49b of the semicircular arc portion 49. At least the leading ends 50a and 51a of the straight portions 50 and 51 extend to a vicinity of the top 3e of the lower portion (i.e. the portion disposed towards the void space 53) 3b of the outer circumferential plane 3.

How an inflator housing 2 filled with a pressurized gas G is subjected to a pressure test using the pressure test device 20 described above is now described. As can be seen in FIG. 3, the not-shown transfer mechanism firstly transfers the housing 2 from the preparation position PP to the waiting position WP, then to the heating position HP. When the power supply 41 of the induction heating apparatus 40 is turned on, the heating coil 46 generates magnetic field lines, such that eddy currents are generated in the housing 2 and the housing 2 is heated to a predetermined temperature. Then the power supply 41 is turned off and, the housing 2 is transferred from the heating position HP to the waiting position WP, then to the ejection position EP. The ejected housing 2 is subjected to judgment as to whether it is leaking gases or whether it has a trace of gas leakage. The pressure test is thus completed.

Since the heating apparatus heats the housing 2 directly by means of induction heating, the pressure test device 20 of the illustrated embodiment is able to heat the inflator housing 2 more quickly for a pressure test than a conventional way of testing with the use of an electric furnace. Further, the pressure test device 20 of the illustrated embodiment uses less energy than the electric furnace in order to heat the housing 2 to a predetermined temperature. Specifically, the pressure test device 20 spent approximately only one fifth of the electricity that the conventional electric furnace required for the test. Moreover, the pressure test device 20 is able to conduct a pressure test merely by heating an inflator housing 2 filled with a gas (pressurized gas) G, thus is able to conduct the test more easily than another conventional way of testing with the use of water.

Therefore, the pressure test device 20 of the illustrated embodiment is conducive to an easier, quicker and more energy-saving pressure test of the housing 2 of the inflator 1.

If the inflator housing 2 as subjected to the pressure test is judged to have a sufficient pressure resistance (i.e. if the housing 2 has no trace of gas leakage due to breakage of a burst disc 9, 12 or due to deficient welding), the housing 2 can be used as the inflator 1. Such a housing 2 is filled with propellant 15 and assembled with the squib 14 as shown in (C) of FIG. 2 to produce the inflator 1. To the contrary, if the housing 2 as ejected from the pressure test device 20 shows a trace of gas leakage, it is unadapted for use as the inflator 1, thus is discarded.

In the pressure test device 20 of the illustrated embodiment, the heating coil 46 for causing induction heating is disposed at a position in the direction YD perpendicular to the axial direction XD of the inflator housing 2 as set at the heating position HP.

With this configuration, since the inflator housing 2 is generally cylindrical in outer contour and the heating coil 46 is disposed at a position in the direction YD perpendicular to the axial direction XD of the inflator housing 2 as set at the heating position HP, induction heating occurs generally uniformly in a generally entire area in the axial direction XD of the housing 2, thus heating the housing 2 quickly.

The heating coil 46 of the foregoing embodiment is configured to encircle a generally half circumference of the housing 2 as set at the heating position HP. Alternatively, in order that the induction heating coil 46 is disposed at a position in the direction YD perpendicular to the axial direction XD of the inflator housing 2 as set at the heating position HP, it is conceivable to form the heating coil 46 into a flat plate as can be seen in FIG. 5A and locate the same generally immediately beneath the ceiling wall section 22 of the cover 21. Further alternatively, the heating coil 46 may be formed into such a helical tube or hose that has an inner diameter great enough to accommodate the inflator housing 2 such that the housing 2 may be inserted into the coil 46 as formed into a tube and heated there, at the heating position HP. In either instance of the above alternative configurations, the housing 2 will be heated generally uniformly over the entire length by induction heating when the heating coil 46 is fed with a high-frequency electric current.

In the pressure test device 20 of the illustrated embodiment, the induction heating coil 46 is configured to include the void space 53 that extends over a generally entire length of the housing 2, and is configured to encircle the upper portion 3a of the outer circumference 3 of the inflator housing 2 opposed to the void space 53 over the generally entire length. This configuration enables a setting of the housing 2 at the heating position HP and an ejection of the housing 2 out of the heating position HP to be conducted via the void space 53 like in the illustrated embodiment, in which the housing 2 held by the holding member 26 and placed on the waiting position WP is moved upward and set at the heating position HP via the void space 53, and then ejected back to the waiting position WP via the void space 53. Since no conducting wire 43 is disposed in the void space 53, the setting and ejection of the housing 2 can be conducted easily with no fear of interference by the conducting wire 43, which will be conducive to a speed-up of the pressure test.

In the pressure test device 20 of the illustrated embodiment, the heating coil 46 is formed into such a bent plate shaped generally like a half-pipe that is adapted to encircle the upper portion 3a of the outer circumference 3 of the inflator housing 2 (i.e. the portion 3a of the outer circumference 3 opposed to the void space 53).

With this configuration, the heating coil 46 encircles the upper portion 3a of the outer circumference 3 of the inflator housing 2 (i.e. the portion 3a of the outer circumference 3 opposed to the void space 53) in proximity over a generally entire length of the housing 2 as set at the heating position HP. This will improve an efficiency in induction heating of the housing 2, thus contributing to energy-saving in the pressure test.

If such an advantageous effect does not have to be considered, the heating coil 46 may be formed into a flat spiral instead of a bent plate as illustrated in FIG. 5A and disposed immediately beneath the ceiling wall section 22 of the cover 21, Such a configuration will yet form a great void space 53 continuous with the gateway 24 below the coil, and facilitate a setting and an ejection of the housing 2 in and out of the heating position HP.

In the illustrated embodiment, moreover, the projected contour of the heating coil 46 as viewed from the axial direction XD of the inflator housing 2 as set at the heating position HP is such a U shape (particularly, an inverse U shape) that includes the semicircular arc portion 49 which is opposed to the void space 53 and covers a generally half circumference 3a of the inflator housing 2 and a pair of the straight portions 50 and 51 that extend straightly in parallel to each other from both ends 49a and 49b of the semicircular arc portion 49. The leading ends 50a and 51a of the straight portions 50 and 51 extend to a vicinity of the top 3e of the lower portion 3b of the outer circumference 3 of the inflator housing 2 (i.e. the top 3e of the portion 3b of the outer circumference 3 of the inflator housing 2 disposed towards the void space 53).

With this configuration, when the inflator housing 2 is disposed at the heating position HP, the semicircular arc portion 49 of the heating coil 46 disposed opposite to the void space 53 encircles the upper half outer circumferential portion 3a of the housing 2 in proximity and the straight portions 50 and 51 are disposed proximate to the lower side portions 3c and 3d (see FIG. 3) of the outer circumference 3 though not in an encircling manner, thus the coil 46 encircles a generally entire outer circumference 3 of the housing 2 over the entire length except a portion facing the void space 53. Therefore, the heating coil 46 is able to heat the housing 2 efficiently by induction heating. Needless to say, the void space 53 has an opening width greater than a diameter ID (FIG. 3) of the housing 2 and is disposed at a position in the direction YD perpendicular to the axial direction XD of the housing 2 as set at the heating position HP, thereby facilitating setting and ejection of the inflator housing 2 in and out of the heating position HP by the heating coil 46.

In the pressure test device 20 of the illustrated embodiment, the void space 53 is disposed at a lower portion of the heating coil 46 such that the heating coil 46 receives the inflator housing 2 as laid horizontally from below the void space 53.

With this configuration, if the inflator housing 2 as laid horizontally is moved upward from the waiting position WP into the heating coil 46 via the void space 53, the housing 2 is set at the heating position HP proximate to the coil 46. Further, since the setting of the inflator housing 2 at the heating position HP can be conducted merely by moving the housing 2 upward, the holding member 26 may be composed of such a member as the holding sections 27 (27A, 27B) of the foregoing embodiment that merely supports the underside of the housing 2, i.e. the holding member does not have to be composed of a chucking mechanism or the like that grips the housing 2. Each of the holding sections 27 of the foregoing embodiment includes, on the top plane 28, a V-shaped holding recess 29 that accommodates the housing 2 and prevents the housing 2 from slipping or rotating. Although a chucking mechanism or the like would be likely to be formed of metal material including a spring or the like, such a holding member as the holding member 26 of the foregoing embodiment may be fabricated of non-conducting material like synthetic resin. That way the pressure test device 20 will have only to heat the inflator housing 2 but not the holding member 26, and heating of the inflator housing 2 will be conducted further efficiently.

What is claimed is:

1. A pressure test device for testing a heat resistance of an inflator housing, comprising:
a heating apparatus that heats the inflator housing which is made from metal into a generally cylindrical contour and is filled with a gas, the heating apparatus including:
a conducting wire;
a heating coil that is connected with the conducting wire and causes induction heating in the inflator housing as set at a heating position; and
a power supply that feeds a high-frequency electric current to the conducting wire.

2. The pressure test device of claim 1, wherein the heating coil is disposed at a position in a direction perpendicular to an axial direction of the inflator housing as set at the heating position.

3. The pressure test device of claim 2, wherein:
the heating coil includes a void space that serves as an insert/eject port of the inflator housing into and out of the heating position; and
the heating coil is configured to cover a portion of an outer circumference of the inflator housing opposed to the void space over a generally entire length.

4. The pressure test device of claim 3, wherein the heating coil is formed into such a bent plate shaped generally like a half-pipe that is adapted to encircle the portion of the outer circumference of the inflator housing opposed to the void space.

5. The pressure test device of claim 4, wherein:
a projected contour of the heating coil as viewed from the axial direction of the inflator housing as set at the heating position is such a U shape that includes a semicircular arc portion which is opposed to the void space and covers a generally half circumference of the inflator housing and a pair of straight portions that extend straightly in parallel to each other from both ends of the semicircular arc portion; and
at least leading ends of the straight portions extend to a vicinity of a top of a portion of the outer circumference of the inflator housing disposed towards the void space.

6. The pressure test device of claim 3, wherein the void space is disposed at a lower portion of the heating coil such that the heating coil receives the inflator housing as laid horizontally from below the void space.
